(19) United States
(12) Patent Application Publication
(10) Pub. No.: US 2005/0064902 A1
(43) Pub. Date: Mar. 24, 2005

(54) Mobile telephone having a vital sign measuring capability

(75) Inventors: Norman Goris, Dortmund (DE); Wolfgang Scheit, Lochhofen/Sauerlach (DE)

Correspondence Address: HITT GAINES, PC;AGERE SYSTEMS INC., PO BOX 832570, RICHARDSON, TX, 75083, US

(73) Assignee: Agere Systems, Incorporated, Allentown, PA (US)

(21) Appl. No.: 10/670,107

(22) Filed: Sep. 24, 2003

(51) Int. Cl. H04M 1/00; H04B 1/38

(52) U.S. Cl. 455/556.1; 455/550.1

(57) ABSTRACT

A mobile telephone, a method of employing a mobile telephone to measure a vital sign and a vital sign measuring system. In one embodiment, the mobile telephone includes: (1) a vital sign measuring system, (2) a keypad, coupled to the vital sign measuring system, configured to allow a user to control the vital sign measuring system and (3) a display, coupled to the vital sign measuring system, configured to provide vital sign information to the user. In other embodiments, a microphone on the mobile phone allows the user to control the vital sign measuring system by voice command, and a loudspeaker on the mobile phone provides the vital sign information to the user.

### TECHNICAL FIELD OF THE INVENTION

The present invention is directed, in general, to wireless telecommunications and, more specifically, to a mobile communication apparatus, in particular to a mobile telephone having a vital sign measuring capability.

### BACKGROUND OF THE INVENTION

Circumstances may arise, for example a mountain trek, during which it may become necessary to measure vital signs (e.g., body temperature, blood pressure or pulse rate) that may help to indicate the health of a living body, but conventional vital sign monitoring equipment is not available. Even were it to be available, the electrical power necessary to operate it is often not available.

It may also become necessary to measure vital signs when power is available, such as when a person is home. Unfortunately, the person wishing to measure vital signs must have or borrow the necessary equipment. Such equipment tends to be relatively expensive and takes space to store when not in use.

Accordingly, what is needed in the art is an improved way to monitor vital signs such that conventional vital sign monitoring equipment is not needed.

### SUMMARY OF THE INVENTION

Since mobile communication apparatus (e.g., mobile telephones) are becoming more and more ubiquitous, the invention recognizes that additional vital sign monitoring equipment can be avoided in many situations. Therefore, to address the above-discussed deficiencies of the prior art, the present invention provides a mobile telephone, a method of employing a mobile telephone to measure a vital sign and a vital sign measuring system.

In one embodiment, the mobile telephone includes: (1) a vital sign measuring system, (2) a keypad, coupled to the vital sign measuring system, configured to allow a user to control the vital sign measuring system and (3) a display, coupled to the vital sign measuring system, configured to provide vital sign information to the user.

In another aspect, the present invention provides a method of employing a mobile telephone to measure a vital sign. In one embodiment, the method includes: (1) controlling a vital sign measuring system coupled to the mobile telephone with a keypad of the mobile telephone and (2) providing vital sign information to the user with a display of the mobile telephone.

In yet another aspect, the present invention provides a vital sign measuring system. In one embodiment, the system includes: (1) a body temperature sensor, (2) a blood pressure sensor, (3) a pulse detector, (4) a mobile telephone interface and (5) control circuitry coupled to the body temperature sensor, the blood pressure sensor, the pulse detector and the mobile telephone interface, configured to provide vital sign information to a user via the mobile telephone interface and a mobile telephone coupled thereto in response to control signals received from the mobile telephone via the mobile telephone interface.

The foregoing has outlined, rather broadly, preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention in its broadest form.

### BRIEF DESCRIPTION OF THE DRAWINGS

For a more complete understanding of the present invention, reference is now made to the following descriptions taken in conjunction with the accompanying drawings, in which:

FIG. 1 illustrates a schematic diagram of one embodiment of a mobile telephone having a vital sign measuring capability constructed according to the principles of the present invention; and

FIG. 2 illustrates a schematic diagram of one embodiment of a method of employing a mobile telephone to measure a vital sign carried out according to the principles of the present invention.

### DETAILED DESCRIPTION

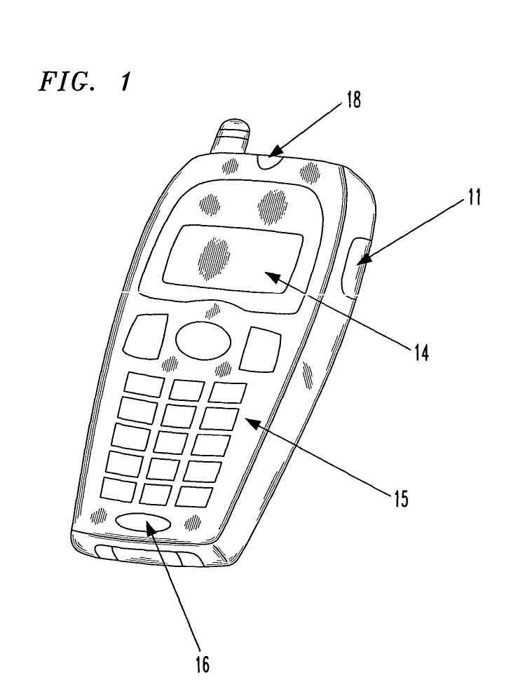

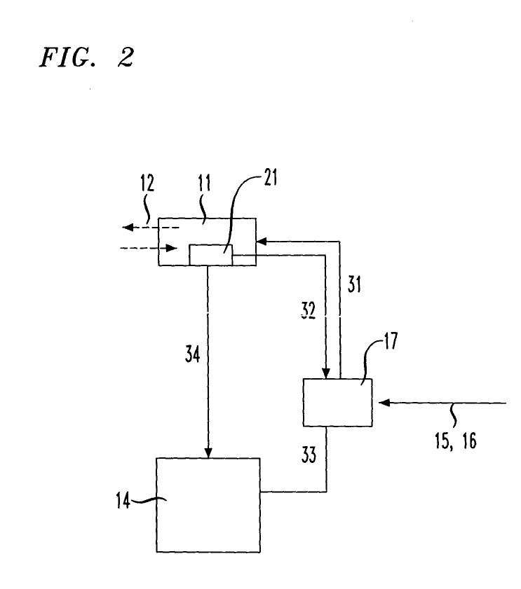

Referring initially to FIG. 1, illustrated is a schematic diagram of one embodiment of a mobile telephone having a vital sign measuring capability constructed according to the principles of the present invention. The mobile telephone is of a mobile radio telecommunication system and has a loudspeaker 18, a microphone 16, a display 14 and a keypad 15. Furthermore, a sensor 11 is integrated at a rear side with regard to the display 14. In the illustrated embodiment, the sensor 11 is a blood pressure sensor and is part of a vital sign measuring system integrated in the chassis (not separately referenced) of the mobile telephone, as described in more detail below with regard to FIG. 2. Based on respective specific applications, the vital sign measuring system may comprise hardware and/or software. Software is advantageous in that it can be integrated with software already present in conventional mobile telephones. In the illustrated embodiment, the vital sign measuring system comprises software executing in a central processing unit (not shown) of the mobile telephone.

For the practical use, preferably at least one sensor is assigned to the vital sign measuring system providing a measurement signal. In this regard, the at least one sensor may be integrated within the mobile telephone. Whether or not the vital sign measuring system is integrated into the chassis of the mobile telephone, a mobile telephone interface is provided for the electrical connection therebetween.

In relatively simple embodiments, a conventional low-cost sensor is sufficient to measure vital signs, such as body temperature, blood pressure or heart pulse rate. Correspondingly, a sensor capable of monitoring only a close range is sufficient for many applications. In the illustrated embodiment, the sensor 11 is attached to a rear side with regard to the display 14 of the mobile telephone to enable the user to simultaneously observe the indication during a measurement.

The sensor 11 may be a heat flow, temperature, frequency, load or pressure sensors and/or is constructed to provide in response to a detected pressure, temperature and/or frequency a signal related therewith. The sensor 11 may be constructed as being an inductive or capacitive sensor and may be adapted to produce a magnetic field for providing a frequency-dependent signal.

In an alternative embodiment, the vital sign measuring system includes a body temperature sensor, a blood pressure sensor, a pulse detector and a mobile telephone interface. The vital sign measuring system further includes control circuitry coupled to the body temperature sensor, the blood pressure sensor, the pulse detector and the mobile telephone interface. The control circuitry is configured to provide vital sign information to a user via the mobile telephone interface and a mobile telephone coupled thereto in response to control signals received from the mobile telephone via the mobile telephone interface.

Turning now to FIG. 2, illustrated is a schematic diagram of one embodiment of a method of employing a mobile telephone to measure a vital sign carried out according to the principles of the present invention. As FIG. 2 indicates, the measuring system can be activated by pressing a predefined key sequence of the keypad 15 of FIG. 1 or by speech control via the microphone 16 of FIG. 1. In particular, the mobile telephone includes an implemented menu list out of which a respective measurement functionality item has to be selected for starting the measurement. By activating the vital sign measuring system, a central processing unit 17 controls and manages the measurement.

In response to the activation the sensor 11 is activated by control circuitry as indicated by a reference sign 31. For measuring blood pressure, the sensor 11 is correspondingly placed on the skin of a living body. For the necessary close range monitoring of the sensor 11, as indicated by a reference sign 12, the sensor 11 comprises a silicon micro-machined sensor die which is sensitive to pressure and temperature for providing a pressure and temperature related analog voltage signal which then is converted by an analog-to-digital converting interface integrated circuit 21 of the sensor 11 into corresponding digital data for further processing.

Based on a first implemented measurement procedure, the digital data is received by the control circuitry 17, as indicated by a reference sign 32, to process the data in an appropriate manner prior to indicate, as indicated by a reference sign 33, the measurement on the display 14. As an alternative implemented measurement procedure, the converted digital data may be directly indicated, as referenced by an arrow 34, on the display 14. Based on the example with the sensor arranged on a rear side of the display, the user of the mobile telephone is able to observe the indication during the measurement.

It is mentioned however, that even an analog signal may be indicated on the display, so that an analog-to-digital in interface 11 is not is not necessary and hence, a standard or low-cost-sensor may be used.

Moreover, also a further conversion into speech is suggested for an indication of the measurement results via the speaker 8, in case a corresponding data to speech conversion system is implemented within the mobile telephone, an integrated chip thereof or within the control circuitry 17 itself.

In alternative embodiments, other mobile communication apparatus may be supplemented with a vital sign measurement system, for example a personal digital assistant (PDA) or a mobile digital assistant (MDA). By providing respective interfaces at the mobile communication apparatus and at the system, an externally connectable system can be used.

Although the present invention has been described in detail, those skilled in the art should understand that they can make various changes, substitutions and alterations herein without departing from the spirit and scope of the invention in its broadest form.

1. A mobile telephone, comprising:
a vital sign measuring system;
a keypad, coupled to said vital sign measuring system, configured to allow a user to control said vital sign measuring system; and
a display, coupled to said vital sign measuring system, configured to provide vital sign information to said user.

2. The mobile telephone as recited in claim 1 wherein said vital sign measuring system comprises a body temperature sensor.

3. The mobile telephone as recited in claim 1 wherein said vital sign measuring system comprises a blood pressure sensor.

4. The mobile telephone as recited in claim 1 wherein said vital sign measuring system comprises a pulse detector.

5. The mobile telephone as recited in claim 1 wherein said vital sign measuring system is integral with a chassis of said mobile telephone.

6. The mobile telephone as recited in claim 1 further comprising a loudspeaker, coupled to said vital sign measuring system, configured to provide said vital sign information to said user.

7. The mobile telephone as recited in claim 1 further comprising a microphone, coupled to said vital sign measuring system, configured to allow said user to control said vital sign measuring system.

8. A method of employing a mobile telephone to measure a vital sign, comprising:
controlling a vital sign measuring system coupled to said mobile telephone with a keypad of said mobile telephone; and
providing vital sign information to said user with a display of said mobile telephone.

9. The method as recited in claim 8 wherein said vital sign measuring system comprises a body temperature sensor.

10. The method as recited in claim 8 wherein said vital sign measuring system comprises a blood pressure sensor.

11. The method as recited in claim 8 wherein said vital sign measuring system comprises a pulse detector.

12. The method as recited in claim 8 wherein said vital sign measuring system is integral with a chassis of said mobile telephone.

13. The method as recited in claim 8 further comprising providing said vital sign information to said user with a loudspeaker of said mobile telephone.

14. The method as recited in claim 8 further comprising controlling a vital sign measuring system coupled to said mobile telephone with a microphone of said mobile telephone.

15. A vital sign measuring system, comprising:
a body temperature sensor;
a blood pressure sensor;
a pulse detector;
a mobile telephone interface; and
control circuitry coupled to said body temperature sensor, said blood pressure sensor, said pulse detector and said mobile telephone interface, configured to provide vital sign information to a user via said mobile telephone interface and a mobile telephone coupled thereto in response to control signals received from said mobile telephone via said mobile telephone interface.

16. The system as recited in claim 15 wherein said system is integral with a chassis of said mobile telephone.

17. The system as recited in claim 15 wherein said control circuitry provides said vital sign information to said user via a display of said mobile telephone.

18. The system as recited in claim 15 wherein said control circuitry provides said vital sign information to said user via a loudspeaker of said mobile telephone.

19. The system as recited in claim 15 wherein said control circuitry accepts commands from a keypad of said mobile telephone.

20. The system as recited in claim 15 wherein said control circuitry accepts commands from a microphone of said mobile telephone.
